(19) United States
(12) Patent Application Publication
(10) Pub. No.: US 2025/0196729 A1
(43) Pub. Date: Jun. 19, 2025

(54) LONGITUDINAL SEAT-ADJUSTMENT DEVICE AND VEHICLE SEAT

(71) Applicant: Adient US LLC, Plymouth, MI (US)

(72) Inventors: Ingo QUAST, Düsseldorf (DE); Erik SPRENGER, Wermelskirchen (DE); Kornel ZALAVARI, Solingen (DE); Maros ROVNY, Adamovské Kochanovce (SK); Turgay TURAN, Kerpen (DE)

(21) Appl. No.: 18/979,914

(22) Filed: Dec. 13, 2024

(30) Foreign Application Priority Data
Dec. 15, 2023 (DE) 10 2023 212 795.4
May 28, 2024 (DE) 10 2024 204 941.7

(51) Int. Cl. B60N 2/08; B60N 2/07

(52) U.S. Cl. CPC B60N 2/0875; B60N 2/0702

(57) ABSTRACT

A longitudinal seat-adjustment device may have one rail arrangement having at least one rail pair and at least one locking element. The rail arrangement is formed from a top rail and a bottom rail, which are movable relative to one another. The at least one locking element is retained in a spring-loaded and movable manner on the top rail and blocks a movement of the top rail in the bottom rail in a locking position, and enables a movement in an unlocking position. A single locking spring is provided, which may have a first spring portion for locking abutment against a first side of the locking element and a second spring portion for locking abutment against a second side of the locking element, the second side lying opposite the first side. A vehicle seat having such a longitudinal seat-adjustment device is also provided.

### FIELD

The invention relates to a longitudinal seat-adjustment device and to a vehicle seat having such a longitudinal seat-adjustment device.

### BACKGROUND

A longitudinal seat-adjustment device generally comprises two rail pairs arranged spaced apart, which are each constructed from two rails, a top rail associated with the seat and a bottom rail associated with the floor of a vehicle. The longitudinal seat-adjustment device furthermore comprises at least one spring-loaded, movable, plate-shaped locking part, which is held on the top rail and, in a locking position, blocks a movement of the top rail in the bottom rail. In this case, the bottom rail can have apertures, while the top rail is provided with openings, and the locking part carries projections on its two opposite longitudinal sides, which projections are movable by a spring both into the openings and into the apertures in the locking position. A longitudinal seat-adjustment device of this kind is known from European Patent EP 1 227 950 B1, for example.

The problem to be solved by the invention is that of improving a longitudinal seat-adjustment device of the type stated at the outset, in particular that of providing a longitudinal seat-adjustment device which makes as little noise as possible, even in a locked state, and a corresponding vehicle seat.

According to the invention, the first-mentioned problem is solved by means of a longitudinal seat-adjustment device having the features of claim 1. According to the invention, the problem mentioned second is solved by means of a vehicle seat having the features of claim 10.

Developments of the invention form the subject matter of the dependent claims.

### SUMMARY

The longitudinal seat-adjustment device according to the invention comprises at least one rail pair and at least one locking element, wherein the rail pair is formed from a top rail and a bottom rail, which are movable relative to one another, wherein the at least one locking element is retained in a spring-loaded and movable manner on the top rail and blocks a movement of the top rail in the bottom rail in a locking position, and enables a movement in an unlocking position, and wherein a single locking spring is provided, which comprises a first spring portion for locking abutment against a first side of the locking element and a second spring portion for locking abutment against a second side of the locking element, said second side lying opposite the first side.

By virtue of the fact that the locking spring has two spring portions with mutually opposite abutment surfaces on the locking element, said locking element can be secured, in particular positioned and held or fixed, in a defined locking location, in particular perpendicularly to the locking direction, e.g. in the vertical direction. In other words: in particular, the two spring portions rest against mutually opposite abutment surfaces or abutment points on the locking element in such a way that this locking element is secured, in particular positioned and held or fixed in a defined locking location, in particular perpendicularly to a locking direction.

In particular, the locking element can be secured or fixed in a locking receptacle, being spring-loaded by means of the locking spring. For example, the locking spring is configured in such a way that the locking element is secured or fixed without play in the locking receptacle of the rail arrangement, at least perpendicularly to the locking direction.

The advantages obtained by means of the invention consist, in particular, in that, instead of the use of two springs, only one locking spring is now required, which ensures a defined locking location of the locking element, which is designed as a locking plate, for example. By virtue of the ability to set such a defined locking location, what is referred to as “rolling” of the locking element, in particular the locking plate, about an axis of rotation, in particular about an axis of rotation running in the longitudinal direction, due to impulses and accelerations during an accident, can be at least reduced or avoided. It is thereby furthermore possible to avoid unwanted opening of the locking system since the locking element is fixed in a spring-loaded manner in the locking location and cannot be moved out of the locking location, in particular cannot be moved below a stop element.

The locking element is, in particular, a single locking plate. The locking of the rail arrangement is therefore also referred to as single-plate locking. On one side, the locking element can lock the top rail, in particular a “slider”, to the bottom rail. By virtue of their non-self-locking angle of obliquity, the play-eliminating locking teeth of the locking element designed as a locking plate drive the locking plate out of locking situations in the locking location in a transverse direction, in particular in a Y direction, counter to a spring force when there is an overload, and, in particular, against a stop element. In this case, the locking teeth can still engage in locking receptacles both of the top rail, in particular in a hole pattern of a top rail designed as a U bracket, and in locking receptacles of the bottom rail. In this way, the top rail (=slider) and bottom rail remain locked. When the rail arrangement is unlocked, the locking plate can, in turn, be moved, in particular pushed, under the stop element against the spring force and then moved, in particular pulled, sideways fully, at least out of the locking receptacles, e.g. the hole pattern, of the bottom rail, such that longitudinal rail adjustment is then possible.

For example, the spring portions of the locking spring can be designed in such a way that they cross one another in a position in which they are inserted on the locking element and fix, in particular vertically fix, the locking element. The locking element can thereby be fixed or secured, in particular perpendicularly to the locking direction and are thus vertically secured, ensuring that rotation of the locking element is blocked. In other words: the locking spring has two spring portions, which cross one another, which spring portions rest by means of their free ends on opposite sides or surfaces of the locking element, and are supported thereon. As a result, the locking element is secured and held or fixed vertically in its position.

For example, the locking spring can be designed as a leg spring, wherein the spring portions are designed as legs. A first leg of the locking spring can be supported, for example, at a first abutment point of the locking element. A second leg can be supported at a second abutment point of the locking element. The two legs (also referred to as spring legs or free spring legs) each exert a force on the locking element in order to prevent or block an unwanted movement of the locking element out of its locking position.

The first leg can be designed to be shorter than the second leg, for example. A free end of the short first leg can rest against and be supported on a first plate end, for example. A free end of the long second leg can rest against and be supported on a second plate end, for example. The locking element is designed as a rectangular plate, for example. The two plate ends are, for example, the mutually opposite edges or edge regions of the short plate sides.

A free end of the first leg or the first leg itself of the locking spring can be of U-shaped design, for example. This makes it possible, for example, to accommodate or arrange a spring retainer of the locking element in the first leg. The locking element can thereby be additionally secured in the longitudinal direction.

A free end of the second leg of the locking spring can be of L-shaped design. In particular, the free end of the second leg can be bent away from the locking element. This results in better support on the locking element.

A vehicle seat according to the invention is provided with the above-described longitudinal seat-adjustment device with the improved locking system.

### DESCRIPTION OF THE FIGURES

The invention is explained in greater detail below with reference to advantageous exemplary embodiments illustrated in the figures. However, the invention is not restricted to these exemplary embodiments. Of the figures:

FIG. 1: shows, in a schematic illustration, a vehicle seat having a longitudinal adjustment device according to the prior art,

FIG. 2: shows a section through a longitudinal adjustment device in the region of a prior art locking element,

FIG. 3: shows a plan view of the end of a top rail of a longitudinal adjustment device according to the invention with a single locking spring,

FIG. 4 shows a perspective illustration of the longitudinal adjustment device without the bottom rail,

FIG. 5 shows another perspective illustration of the longitudinal adjustment device without the bottom rail,

FIG. 6 shows another perspective illustration of the longitudinal adjustment device without the bottom rail, and

FIG. 7 shows another perspective illustration of the longitudinal adjustment device without the bottom rail.

### DETAILED DESCRIPTION

In all the figures, mutually corresponding parts are provided with the same reference signs.

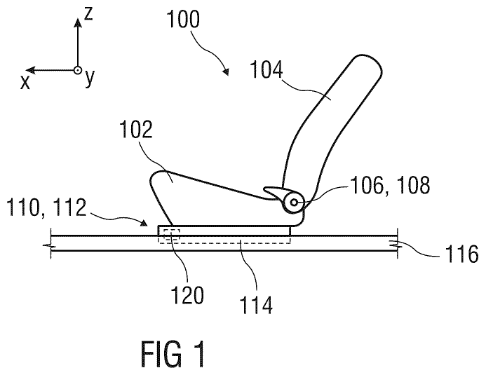

A vehicle seat 100 illustrated schematically in FIG. 1, which relates to the prior art, is described below using three spatial directions perpendicular to one another. In the case of a vehicle seat 100 installed in the vehicle, a longitudinal direction x runs largely horizontally and preferably parallel to a vehicle longitudinal direction, which corresponds to the normal driving direction of the vehicle. A transverse direction y, which runs perpendicularly to the longitudinal direction x, is likewise aligned horizontally in the vehicle and runs parallel to a vehicle transverse direction. A vertical direction z runs perpendicularly to the longitudinal direction x and perpendicularly to the transverse direction y. With a vehicle seat 100 installed in the vehicle, the vertical direction z preferably runs parallel to a vehicle vertical axis.

The position indications and direction indications used, such as front, rear, top and bottom, refer to a direction of view of an occupant sitting in a normal sitting position in the vehicle seat 100, wherein the vehicle seat 100 is installed in the vehicle, in a use position suitable for carrying people, with the seat back 104 upright, and is oriented in the usual manner in the direction of travel. However, the vehicle seat 100 can also be installed or moved in a different orientation, e.g. transversely to the direction of travel. Unless otherwise described, the vehicle seat 100 is constructed in mirror symmetry with respect to a plane running perpendicularly to the transverse direction y.

The seat back 104 can be arranged pivotably on a seat part 102 of the vehicle seat 100. For this purpose, the vehicle seat 100 can optionally comprise a fitting 106, in particular an adjustment fitting, rotation fitting, latching fitting or tilt fitting.

The position indications and direction indications used, such as radial, axial and in the circumferential direction, refer to the axis of rotation 108 of the fitting 106. Radial means perpendicular to the axis of rotation 108. Axial means in the direction of or parallel to the axis of rotation 108.

The vehicle seat 100 can optionally comprise a longitudinal adjustment device 110. The longitudinal adjustment device 110 comprises, for example, a rail arrangement 112 having a first rail element 114 and a second rail element 116. The first rail element 114 is adjustable relative to the second rail element 116 in the longitudinal direction x. The first rail element 114 is secured on the seat part 102. The second rail element 116 is secured on a structural element of a vehicle, e.g. a vehicle floor.

For greater clarity, the first rail element 114 is referred to as the top rail 114 in the following description. This top rail 114 (also referred to as a running rail or slide) is assigned to the vehicle seat 100 and configured to support this vehicle seat 100. The second rail element 116 is referred to below as the bottom rail 116. The bottom rail 116 is connected in a fixed manner and by way of example to the floor of a vehicle.

In particular, the vehicle seat 100 can comprise two rail arrangements 112 arranged parallel to one another as a longitudinal adjustment device 110. The two rail arrangements 112, which are each designed as a rail pair, for example, are arranged at a distance from and parallel to one another. The two rail pairs may be of substantially identical construction and may correspond to one another in respect of construction and functioning, unless described differently below.

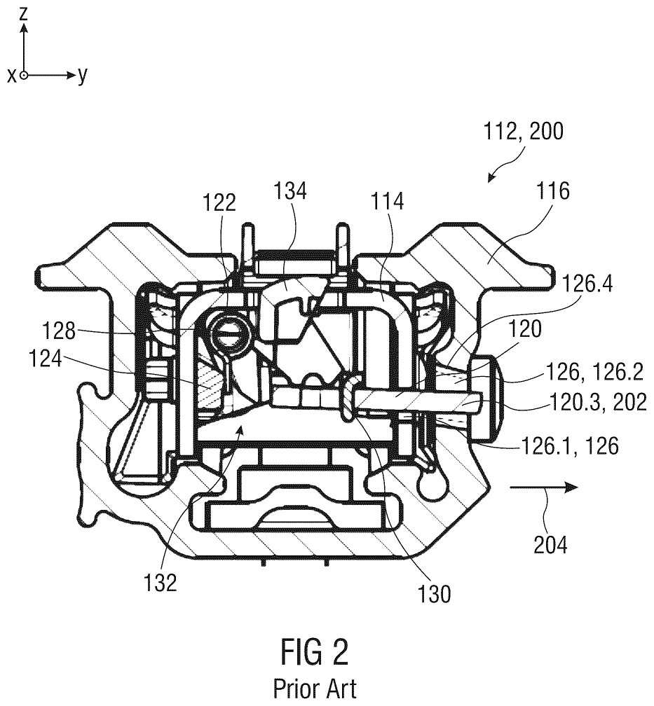

The longitudinal seat-adjustment device 110 furthermore comprises at least one locking element 120. In this case, each rail arrangement 112, designed as a rail pair, can comprise an associated locking element 120, as described in greater detail below with reference to FIGS. 2 to 7.

FIG. 2 shows a section through a rail arrangement 112, designed as a rail pair, of a longitudinal adjustment device 110 in the region of a prior art locking element 120 as per WO 2023/281380 A1.

The locking element 120 is designed as a double lock. For the purposes of the invention, a double lock is understood to mean, in particular, that, in a locking position 200 (illustrated in FIGS. 2 to 7), the locking element 120 on the one hand blocks a movement of the top rail 114 (also referred to as a rail runner) relative to the bottom rail 116 (also referred to as a guide rail) and on the other hand at least limits or blocks unwanted movements of the locking element 120 in the locking position 200 by means of a locking spring 122 and/or a stop element 124.

The locking element 120 can be designed, for example, as a locking plate, in particular as a single separate locking plate, which can lock the top rail 114 to the bottom rail 116. The locking element 120 is also referred to as a single-plate lock.

The at least one locking element 120 is spring-loaded and retained or held movably on the top rail 114, in particular being mounted rotatably and movably, in particular being adjustable or movable in an arc by means of a combined rotary and pulling movement.

The locking element 120 is, in particular, a single locking plate. The locking element 120 is configured to lock the top rail 114, e.g. on one side, to the bottom rail 116. For this purpose, the locking element 120 can be provided, e.g. on one of its longitudinal sides with locking teeth 120.3. The locking teeth 120.3 project from the locking plate in the transverse direction y in the direction of side walls of the top rail 114 and of the bottom rail 116 and, in the locking position 200, into the corresponding locking receptacles 126.

The locking teeth 120.3 of the locking element 120, which eliminate play, can have oblique side walls on their longitudinal sides or a trapezoidal shape. By virtue of this angle of obliquity, in particular a non-self-locking angle of obliquity, on their longitudinal sides, the locking teeth 120.3 drive the locking element 120 out of locking situations or locking positions 200 in transverse direction y, counter to the spring force of the locking spring 122, in the locking location 202 when there is an overload and, in particular, against the stop element 124.

During this process, the locking teeth 120.3 can still engage in first locking receptacles 126.1 of the top rail 114, in particular in a hole pattern in the top rail 114, and in second locking receptacles 126.2 of the bottom rail 116. The top rail 114 and the bottom rail 116 can each be designed as U-shaped profiles or brackets. In this way, the top rail 114 and the bottom rail 116 remain locked. When the rail arrangement 112 is unlocked, the locking plate can, in turn, be moved, in particular pushed, under the stop element 124 against the spring force and then moved, in particular pulled, sideways fully, at least out of the locking receptacles 126.1, 126.2, e.g. the hole pattern, of the bottom rail 116, and therefore longitudinal rail adjustment is possible.

The stop element 124 is arranged in a cavity 132 formed between the top rail 114 and the bottom rail 116. The stop element 124 is, in particular, secured on the top rail 114. The stop element 124 is preferably secured by material bonding, e.g. welded, on the top rail 114. Alternatively, the stop element 124 can be connected by a form fit and/or a force fit to the top rail 114.

The locking element 120 is, for example, guided directly in the latching openings or first locking receptacles 126.1 of the top rail 114, in particular during a movement, in particular pivoting, of the locking element 120 into the locking position 200. During an unlocking movement out of the locking position 200 into an unlocking position (not illustrated), the locking element 120 is unlocked by an actuating element 134, with control being exercised by means of a combined rotary and pulling movement. In the unlocking position, the locking element 120 has been moved at least out of the second locking receptacles 126.2 of the bottom rail 116, thus allowing the top rail 114 to be moved relative to the bottom rail 116. Owing to its rotary and pulling movement, the locking element 120 does not have a defined axis of rotation.

Moreover, the locking spring 122 can, in particular, be designed as a return element 130, in particular as a return spring. During the unlocking process, the return element 130 is put under stress. When the unlocking force is removed, the return element 130 relaxes, with the result that the locking element 120 is automatically returned to the locking position 200 by means of the return element 130. In this case, the return element 130, in particular the spring force thereof, can be configured in such a way that it presses the locking element 120 into the locking position 200. In other words: the locking element 120 is placed, in particular pressed, into the locking position 200 under a spring load, with the result that the top rail 114 and the bottom rail 116 are arranged without play relative to one another. In particular, the top rail 114 and the bottom rail 116 are in this case preloaded in the locking position 200 relative to one another by means of the spring-loaded locking element 120.

In particular, the locking element 120 is arranged and configured in such a way that, during unlocking, it is first of all rotatable over a certain range in the locking position 200 and is then actuable, in particular movable or capable of being pulled linearly or in an arc, out of the locking position 200 into the unlocking position (not illustrated).

In the locking position 200, the locking element 120 is, for example, held in the transverse direction y by a force fit, in particular a frictional fit, and held preloaded in the vertical direction z. In particular, the locking element 120 locks the top rail 114 and the bottom rail 116 in the longitudinal direction x.

To unlock the locking of the top rail 114 and the bottom rail 116, the respective locking element 120 is first of all movable in the longitudinal direction x out of force-fitting retention by means of rotation about an axis of rotation in the locking position 200, in particular is rotatable into an intermediate position and then movable, in particular capable of being pulled, out of the locking position 200 into the unlocking position by means of the linear or arcuate movement.

The sequence of motion during unlocking or locking with a simple stress-catch function for the locking element 120 without additional components through the use of a combined movement of the locking element 120 comprising a rotary movement and a pulling movement takes place in a manner analogous to the disclosure in prior publication WO 2023/281380 A1, to which reference is made in this regard.

In comparison with this publication, the present locking element 120 comprises a modified locking location 202 in the locked situation and thus in the locking position 200. This is achieved by means of the locking spring 122.

In the prior art, the locking element 120 is below an upper edge 126.4 or in contact with the upper edge 126.4 of the hole pattern or the first locking receptacles 126.1 in the top rail 114.

On account of forces introduced in the crash, the top rail 114 is lowered until it is stopped by being supported within the bottom rail 116. This sudden movement, with the locking element 120 being in contact with the upper edge 126.4 in the first locking receptacles 126.1, ensures rotation about an axis in the longitudinal direction x since the play-eliminating locking tooth 120.3 is in contact with respect to the bottom rail 116 and with the latter and generates a virtual pivot point. The further-inward contact point with respect to the top rail 114 is moved downward and leads to a rotation of the locking element 120 with high acceleration. The double locking of the locking element 120 no longer takes effect since the locking element 120 is lowered below the stop element 124. In this case, the locking element 120 can move fully out of the second locking receptacles 126.2 of the bottom rail 116 in the transverse direction y.

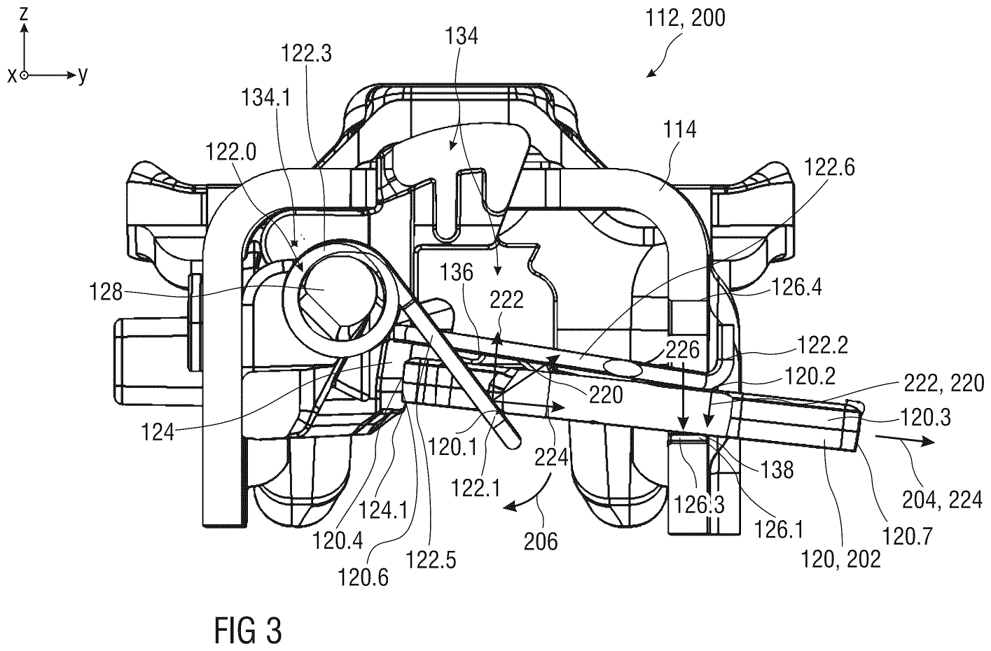

FIG. 3 shows a plan view of the end of the top rail 114 with the rail arrangement 112 of the longitudinal adjustment device 110 according to the invention.

The longitudinal adjustment device 110 differs from that described above in the type and construction of the locking spring 122.0.

In the locking position 200, the locking element 120 blocks a movement, in particular a longitudinal movement, of the top rail 114 in the bottom rail 116 (illustrated in FIG. 2). In an unlocking position (not illustrated specifically), the locking element 120 allows a movement of the top rail 114 relative to the bottom rail 116. In this case, a single locking spring 122.0 is provided, which comprises a first spring portion 122.1 for locking or fixing abutment against a first abutment point 120.1 of the locking element 120 and a second spring portion 122.2 for locking or fixing abutment against a second abutment point 120.2 of the locking element 120, said second abutment point lying opposite the first abutment point 120.1.

By means of the two spring portions 122.1, 122.2, which rest against the locking element 120 at the mutually opposite abutment points 120.1, 120.2 (e.g. a lower abutment point 120.1, an upper abutment point 120.2), the locking element 120 can be fixed in a defined locking location 202, in particular secured perpendicularly to the locking direction 204, e.g. in the vertical direction z.

In particular, the locking element 120 can be fixed in the locking receptacles 126.1, 126.2 of the top rail 114 and the bottom rail 116 while being spring-loaded by means of the locking spring 122.0. For example, the locking spring 122.0 is configured to fix the locking element 120 without play in the locking receptacles 126.1, 126.2, at least perpendicularly to the locking direction 204.

The advantages achieved by means of the invention consist, in particular, in that a defined locking location 202 of the locking element 120, which is designed as a locking plate, for example, and rests on a lower edge 126.3 of the locking receptacle 126.1 of the top rail 114, is made possible by means of a single locking spring 122.0. Thus, an impact or impulse from above on the locking element 120, with subsequent rolling, can no longer occur. By virtue of such a defined locking location 202 on the lower edge 126.3, which can be set by means of the locking spring 122.0, rolling, in particular, of the locking element 120 about an axis, in particular about an axis running in the longitudinal direction x, due to impulses and accelerations on the locking element 120 during an accident, is avoided. It is thereby furthermore possible to avoid unwanted opening of the locking system since the locking element 120 is fixed in a spring-loaded manner in the locking location 202 and cannot be moved out of the locking location 202, in particular cannot be moved below the stop element 124.

The locking spring 122.0 is mounted on a bearing 128 on the top rail 114.

In particular, the locking spring 122.0 according to the invention has two spring portions 122.1, 122.2, which cross one another in the front view, which spring portions rest by means of their free ends on opposite sides or surfaces of the locking element 120 at the relevant abutment points 120.1, 120.2, and are supported thereon. As a result, the locking element 120 is secured and held or fixed vertically in its position, the locking position 200. Rotation of the locking element 120 is thus made more difficult or inhibited since the location of the locking element 120 is defined in a spring-loaded manner. In particular, the locking element 120 is, on the one hand, pressed down to the maximum possible extent—until it is resting against the lower edge 126.3 in the first locking receptacle 126.1—and, on the other hand, it is raised to the maximum extent by contact of the spring portion 122.1 in the first abutment point 120.1. In particular, a movement (also referred to as rolling) of the locking element 120 about an X axis (=about an axis running in the longitudinal direction x) is avoided.

In particular, the locking spring 122.0 is designed as a leg spring. In this case, the spring portions 122.1, 122.2 form the legs 122.5, 122.6 of the leg spring. A first leg 122.5 of the locking spring 122.0 can be supported, for example, at the first abutment point 120.1. A second leg 122.6 can be supported at the second abutment point 120.2. The two legs 122.5, 122.6 (also referred to as spring legs or free spring legs) each exert a spring force 220 on the locking element 120 according to the invention in order to prevent or inhibit an unwanted movement of the locking element 120 according to the invention out of its locking position 200.

The locking spring 122.0 is in contact by means of the first spring portion 122.1, in particular a first spring leg, with the locking element 120, in particular with a lower side of the locking element 120, at the first abutment point 120.1. In this case, the spring force 220 is divided into a force 222 acting perpendicularly to the locking element 120 and a locking force 224 acting in the locking direction 204. The force component of the spring force 220 is transmitted via a contact point 136 (also referred to as transmission point or actuation point) of the locking element 120 to the actuating element 134, which is designed as an actuating lever, for example. The spring force 220 at the second abutment point 120.2 corresponds approximately to a force 222 acting perpendicularly to the locking element 120.

Thus, in the locked state and hence in the locking position 200 of the rail arrangement 112 and in the locking location 202 of the locking element 120, the actuating element 134 is also pressed into its end stop in a spring-loaded manner. Thus, the actuating element 134 can also be held quietly in the locking position 200 by means of the locking spring 122.0.

The locking spring 122.0 can be designed as a leg spring, the spring body 122.3 of which is preferably supported in a fixed location on the bearing 128, in particular a bearing pin.

The spring portions 122.1, 122.2 are each legs 122.5, 122.6 of the leg spring. The second spring portion 122.2 (=longer spring leg) can be, in particular, longer than the first spring portion 122.1 (=shorter spring leg). The longer spring portion 122.2 extends as far as the second abutment point 120.2 on the locking element 120. The second abutment point 120.2 (also referred to as contact point or fixing point) is situated in the region of a tooth leadthrough and thus of one of the first locking receptacles 126.1 through one of the side walls of the top rail 114 or in the region of the locking holes provided for the teeth or in the region of the first locking receptacles 126.1.

A free end of the short first leg 122.5 (=first spring portion 122.1) can rest against and be supported on the locking element 120 in the region of a first plate end 120.6, for example. A free end of the long second leg 122.6 can rest against and be supported on the locking element 120 in the region of a second plate end 120.7, for example. The locking element 120 is designed as a rectangular plate, for example. The two plate ends 120.6 and 120.7 are, for example, the mutually opposite edges or edge regions of the short plate sides.

By means of a preloading force 226, the locking element 120 is pressed onto a lower edge 126.3 of the first locking receptacle 126.1 for leading through one of the locking teeth 120.3. In this way, it is possible to ensure that impulses during an accident, e.g. introduced by acceleration or contacts with the locking element 120 at an upper edge 126.4 of the first locking receptacles 126.1 in the top rail 114, cannot be transmitted to this locking element 120.

In this way, it is possible to ensure that a rear side 120.4 of the locking element 120 is always at the level of the stop element 124 or at the level of a stop surface 124.1 provided for locking the locking element 120 in the locking direction 204.

During unlocking, the actuating element 134 is pivoted about a bearing axis 134.1. During this process, the locking element 120 is pressed down via the contact point 136 of the actuating element 134 with said locking element. As a consequence, the shorter spring portion 122.1 (shorter/first spring leg) is moved in the stressing direction of the locking spring 122.0 via the first abutment point 120.1 in accordance with arrow 206.

The longer spring portion 122.2 (longer/second spring leg) remains in contact with the locking element 120 at the associated contact point 136, almost at the same height when viewed in the transverse direction y, and undergoes only slight changes in rotation angle due to the pivoting movement of the locking element 120 about a further contact point 138 on the lower edge 126.3 of the locking receptacle 126.1 in the top rail 114.

During this process, the locking spring 122.0 is subjected to stress. During locking, the stored spring energy is released again primarily via the shorter first spring portion 122.1 (also referred to as spring arm or spring leg) to the locking element 120 and produces the locking movement and the secured locking location 202.

In other words: only the locking spring 122.0 ensures ideal contacts of the locking element 120 and the top rail 114 and/or of the actuating element 134 and the locking element 120 in order to keep introduced impulses low or to avoid them entirely. Furthermore, the rear side 120.4 (also referred to as rear surface or reverse side) of the locking element 120 is raised to the maximum extent in order to ensure locking in the locking direction 204 (stop height).

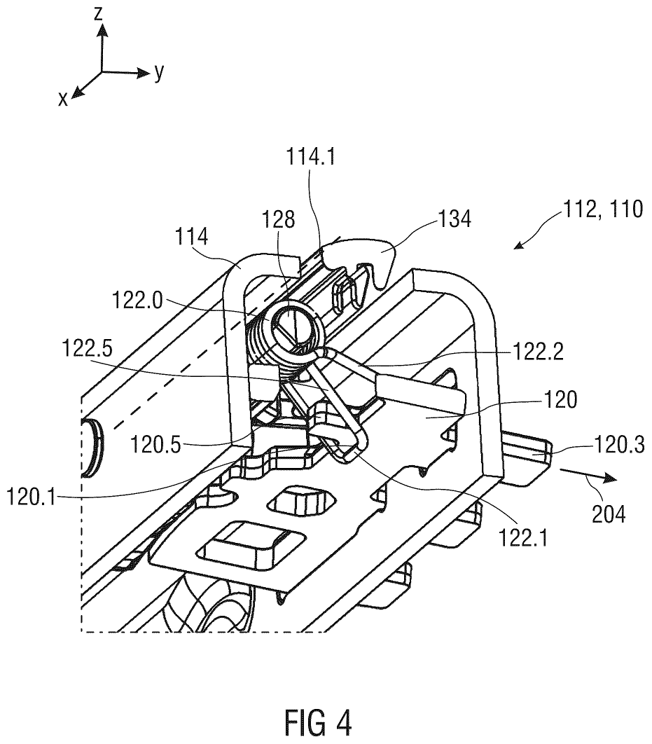

FIG. 4 shows another perspective illustration of the longitudinal adjustment device 110 without the bottom rail 116 in the region of the bearing 128 of the locking spring 122.0 on the top rail 114.

The locking spring 122.0 can be a double leg spring, for example. The first spring portion 122.1 can be of U-shaped design, for example, in particular being designed as a spring end bent in a U shape. The first spring portion 122.1, which is designed as a first leg 122.5, ensures the locking force 224 (illustrated in FIG. 3). This makes it possible, for example, for the first spring portion 122.1 to be accommodated or arranged on or in a bearing location 120.5 (also referred to as a spring holder) of the locking element 120. The locking element 120 can thereby be additionally secured in the longitudinal direction x. The bearing location 120.5 can be designed, for example, as an extension, nose or tooth projecting from the locking element 120. In particular, the bearing location 120.5 projects from the locking element 120 on the opposite side from the locking tooth 120.3. The projecting bearing location 120.5 has a shorter length than the projecting locking tooth 120.3.

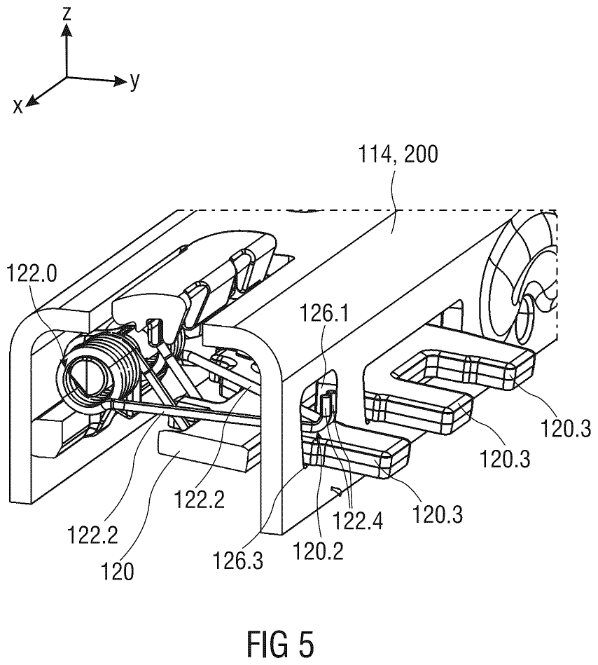

The first spring portion 122.1 (referred to as the central or inner spring arm or spring leg) is arranged centrally between two outer second spring portions 122.2 (also referred to as outer spring arms or outer spring legs, illustrated in FIG. 5) when viewed in the longitudinal direction x.

The actuating element 134 is movably mounted in an upper rail opening 114.1 of the top rail 114. The locking element 120 is of plate-shaped configuration and has locking teeth 120.3 pointing in the locking direction 204.

In the region of the first abutment point 120.1 for the first spring portion 122.1, the locking element 120 has the projecting bearing location 120.5.

FIG. 5 shows another perspective illustration of the top rail 114 with the locking spring 122.0.

The second spring portion 122.2 of the locking spring 122.0 can comprise two outer legs, which are bent at their free spring ends 122.4, in particular perpendicularly upward, or are bent inward. The second spring portion 122.2 has a length in the transverse direction y such that its free spring ends 122.4 project into and optionally through the first locking receptacles 126.1 in the top rail 114. In this case, the spring ends 122.4 press the locking element 120 downward, in particular via the second abutment point 120.2, at one or more of the locking teeth 120.3. The secured locking location 202 of the locking element 120 on the lower edge 126.3 is thereby produced.

For this purpose, the free spring ends 122.4 of the second spring portion 122.2 are of L-shaped design, for example. In particular, the respective free spring end 122.4 is bent away from the locking element 120. This results in better support for the locking spring 122.0 on the locking element 120.

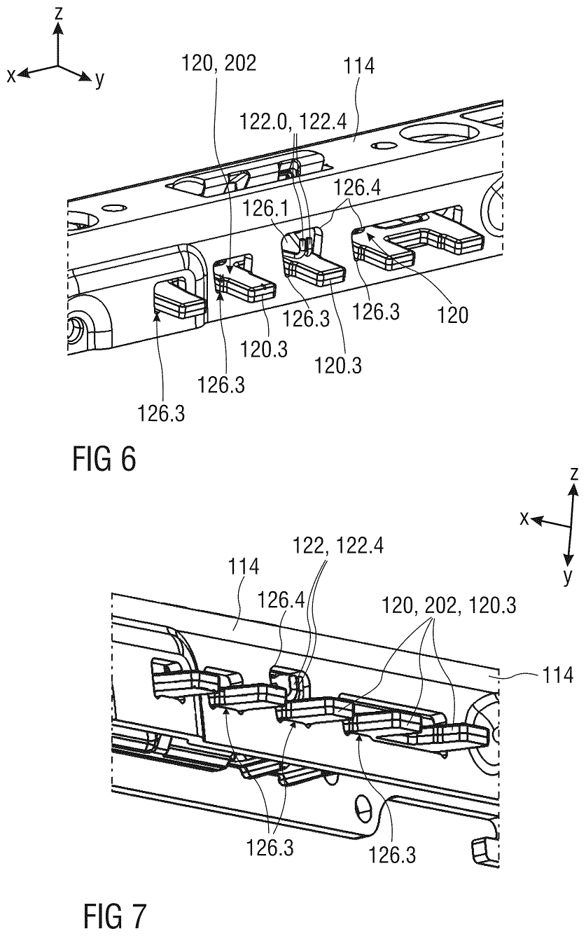

FIGS. 6 and 7 each show another perspective illustration of the top rail 114 with the locking spring 122.0.

In particular, the respective free spring end 122.4 is bent away from the locking element 120 in such a way that these free spring ends 122.4 are arranged in the first locking receptacle 126.1, in particular in a window opening, in the rail arrangement 112 when the locking spring 122.0 is arranged on the locking element 120. As a result, the free spring ends 122.4 can be supported in the first locking receptacle 126.1, in particular on an opening frame.

In this case, the locking element 120 can be pressed in a spring-loaded manner against the lower edge 126.3 of the locking receptacle 126.1 by means of the locking spring 122.0, in particular by means of the free spring ends 122.4, in order to set the defined locking location 202. The locking teeth 120.3 are arranged at a distance from the upper edge 126.4 of the first locking receptacles 126.1. By virtue of this distance, the introduction of impulses in the event of an accident is avoided or at least reduced.

### LIST OF REFERENCE SIGNS

100 vehicle seat
102 seat part
104 seat back
106 fitting
108 axis of rotation
110 longitudinal adjustment device
112 rail arrangement
114 first rail element (top rail)
114.1 upper rail opening
116 second rail element (bottom rail)
120 locking element
120.1, 120.2 abutment point
120.3 locking tooth
120.4 rear side
120.5 bearing location
120.6 first plate end
120.7 second plate end
122 locking spring according to the prior art
122.0 locking spring according to the invention
122.1, 122.2 spring portion
122.3 spring body
122.4 spring end
122.5 first leg
122.6 second leg
124 stop element
124.1 stop surface
126 locking receptacle
126.1 first locking receptacle
126.2 second locking receptacle
126.3 lower edge
126.4 upper edge
128 bearing
130 return element
132 cavity
134 actuating element
134.1 bearing axis
136 contact point
138 further contact point
200 locking position
202 locking location
204 locking direction
206 arrow
220 spring force
222 force
224 locking force
226 preloading force
x longitudinal direction
y transverse direction
z vertical direction

What is claimed is:

1. A longitudinal seat-adjustment device, comprising:
one rail arrangement having at least one rail pair and
at least one locking element,
wherein the rail arrangement is formed from a top rail and a bottom rail, which are movable relative to one another,
wherein the at least one locking element is retained in a spring-loaded and movable manner on the top rail and blocks a movement of the top rail in the bottom rail in a locking position, and enables a movement in an unlocking position, and
wherein a single locking spring is provided, which comprises a first spring portion for locking abutment against a first side of the locking element and a second spring portion for locking abutment against a second side of the locking element, said second side lying opposite the first side.

2. The longitudinal seat-adjustment device according to claim 1, wherein the two spring portions rest against mutually opposite abutment surfaces and/or abutment points on the locking element in such a way that this locking element is secured in a defined locking location.

3. The longitudinal seat-adjustment device according to claim 1, wherein the two spring portions rest against mutually opposite abutment surfaces and/or abutment points on the locking element in such a way that this locking element is secured in a defined locking location perpendicular to a locking direction of this locking element.

4. The longitudinal seat-adjustment device according to claim 3, wherein the locking spring is configured to secure the locking element without play in a locking receptacle of the rail arrangement, at least perpendicularly to the locking direction.

5. The longitudinal seat-adjustment device according to claim 1, wherein the spring portions are designed in such a way that they cross one another in a position in which they are inserted on the locking element and fix the locking element.

6. The longitudinal seat-adjustment device according to claim 1, wherein the locking spring is designed as a leg spring, wherein the spring portions are designed as legs, wherein a first leg is supported at a first abutment point of the locking element, and a second leg is supported at a second abutment point of the locking element.

7. The longitudinal seat-adjustment device according to claim 6, wherein the first leg is designed to be shorter than the second leg.

8. The longitudinal seat-adjustment device according to claim 6, wherein a free end of the first leg is of U-shaped design.

9. The longitudinal seat-adjustment device according to claim 6, wherein a free end of the second leg is of L-shaped design.

10. A vehicle seat having a longitudinal seat-adjustment device according to claim 1.
